(19) United States
(12) Patent Application Publication
(10) Pub. No.: US 2011/0294324 A1
(43) Pub. Date: Dec. 1, 2011

(54) Plug Connector

(75) Inventors: Markus Bihrer, Althengstett (DE); Johann Krech, Horb (DE)

(73) Assignee: LAPP ENGINEERING & CO., Cham (CH)

(21) Appl. No.: 13/105,448

(22) Filed: May 11, 2011

Related U.S. Application Data
(63) Continuation of application No. PCT/EP2009/062750, filed on Oct. 1, 2009.

(30) Foreign Application Priority Data
Oct. 15, 2008 (DE) 102008052822.6

(51) Int. Cl. H01R 13/53; H01R 13/40

(52) U.S. Cl. 439/183; 439/588

(57) ABSTRACT

In order to improve a plug connector comprising a plug connector housing which is designed to be electrically insulating and consists of a plurality of housing parts, at least one contact element which is arranged in a receiving area of the plug connector housing and is accessible for a contact element of a complementary plug connector via a plug opening, and an electric cable which leads into the plug connector housing via a cable opening and the electrical conductor of which is connected to the contact element, in such a manner that the plug connector housing can be configured in as space-saving a manner as possible with creeping current paths which are as large as possible it is suggested that joins between the housing parts and adjoining the receiving area be closed in a materially joined manner and that, as a result, creeping current paths which lead away from the contact element in the receiving area run exclusively to the plug opening and/or to the cable opening.

This application is a continuation of international application number PCT/EP2009/062750 filed on Oct. 1, 2009.

This patent application claims the benefit of international application No. PCT/EP2009/062750 of Oct. 1, 2009, and German application No. 10 2008 052 822.6 of Oct. 15, 2008, the teachings and disclosure of which are hereby incorporated in their entirety by reference thereto.

The invention relates to a plug connector comprising a plug connector housing which is designed to be electrically insulating and is formed from a plurality of housing parts, at least one contact element which is arranged in a receiving area of the plug connector housing and is accessible for a contact element of a complementary plug connector via a plug opening and an electric cable which leads into the plug connector housing via a cable opening and the electrical conductor of which is connected to the contact element.

Plug connectors of this type are known from the state of the art, wherein the problem with them is that joins between the various housing parts have to be taken into consideration when determining creeping current paths since creeping currents also run through joins.

If plug connectors of this type are used for high voltages, correspondingly large creeping current paths have to be provided, proceeding from the contact element, and they make it necessary to dimension the plug connector housing to be correspondingly large in order to be able to realize the necessary creeping current paths in the various directions.

The object underlying the invention is, therefore, to improve a plug connector of the generic type in such a manner that the plug connector housing can be configured in as space-saving a manner as possible with creeping current paths which are as large as possible.

This object is accomplished in accordance with the invention, in a plug connector of the type described at the outset, in that joins between the housing parts and adjoining the receiving area are closed in a materially joined manner and, therefore, creeping current paths which lead away from the contact element in the receiving area run exclusively to the plug opening and/or to the cable opening of the plug connector housing.

The advantage of the solution according to the invention is to be seen in the fact that all the joins between the housing parts which adjoin the receiving area are closed in a materially joined manner and, therefore, creeping current paths passing through these joins no longer occur and, therefore, it can be ensured in a simple manner that the creeping current paths leading via the plug opening and/or the cable opening are sufficiently large.

With respect to the arrangement of the joins, no further details have been given in conjunction with the embodiment described above.

One solution, for example, provides for the joins between the receiving area and an outer side of the plug connector housing to be closed in a materially joined manner.

In this case, the materially joined closure of the joins means that the creeping currents cannot extend directly from the outer area through the joins to the outer side of the plug connector housing but must rather run via the plug opening and/or the cable opening so that sufficiently large creepage paths are obtained with a simple construction.

Particularly when the plug connector has two receiving areas for several contact elements, it is preferably provided for the joins between the receiving areas of the plug connector housing to likewise be closed in a materially joined manner so that in this case, as well, no creeping currents can extend through the joins from one receiving area to the other but the creeping currents must, in this case, also run either via the plug opening and/or the cable opening.

With respect to the course of the joins between the housing parts, no further details have likewise been given.

One solution, for example, in particular a solution which comprises half shells as housing parts, provides for joins between the housing parts to extend parallel to a central axis of the plug connector housing.

With respect to the design of the housing parts, no further details have been given in conjunction with the preceding description of the plug connector housing.

One advantageous solution provides, for example, for the plug connector housing to be made up of three housing parts.

In the case of such a plug connector housing, it is preferably provided for two housing parts to form half shells of a gripping sleeve and the third housing part to represent a contact protection sleeve.

Another solution provides for the plug connector housing to be constructed from two housing parts.

In this case, the two housing parts could represent half shells which are pieced together.

One possibility for designing the housing parts, in particular when they are designed as half shells, provides for the housing parts to be designed to be mirror symmetrical to the central axis of the plug connector housing so that the half shells can be produced as identical parts.

Furthermore, another solution provides for the joins between housing parts to extend parallel to a plane running transversely to the central axis.

For example, the housing parts are, in such a case, designed to be like sleeves, in particular it is conceivable to realize the two housing parts by way of a contact protection sleeve and an end sleeve.

In the case of housing parts designed like sleeves, it is, in principle, possible to design them as sleeves in a polygonal shape.

One particularly simple solution provides, however, for such sleeve-like housing parts to extend cylindrically to the central axis of the plug connector housing.

With respect to the materially joined closure of the joins according to the invention, no further details have so far been given.

One advantageous solution provides for the joins between the housing parts to be closed by welding the housing parts.

Such welding of the joins can be realized, in principle, by the most varied of welding methods. One solution would be, for example, to close the joins of the housing parts by way of laser welding, radiant heat welding, vibration welding or friction welding.

One advantageous solution provides for the joins of the housing parts to be closed by way of ultrasonic welding.

Such ultrasonic welding has the advantage that this can be realized without problem during the course of a production process or manufacturing process for such a plug connector housing since ultrasonic welding can be used after different phases, in which respective housing parts are connected to one another, without impairing any subsequent phase.

In this respect, it is particularly favorable when grooves are provided for the ultrasonic welding in the area of the joins to be welded, these grooves allowing material flowing during the ultrasonic welding to be accommodated at least in part.

A further embodiment, in particular in the case of sleeve-like housing parts, provides for the housing parts to be connected to one another by friction welding.

Another, advantageous solution provides for the housing parts, which are to be connected to one another by ultrasonic welding, to be provided in the area of the joins to be welded with a groove in one housing part and with a tongue engaging in the groove in the other part.

In this case, a softening of the material in the area of the groove and the tongue takes place and the material can then be accommodated at least in part by free spaces in the groove.

Alternatively or in addition to the welding of the joins, another solution provides for the joins to be closed by way of an adhesive material.

Such an adhesive material could, for example, be a bonding agent which is applied to the area of the joins which are formed and hardened.

It is, however, particularly advantageous when the adhesive material is arranged in a recess adjoining the join.

In this respect, the recess could be arranged in the area of the join itself.

It is, however, also conceivable for the recess to be arranged on one side of the join, for example on an inner side of the plug connector housing.

One advantageous solution provides for the join to be closed by the adhesive material in that the adhesive material sticks adhesively to both the housing parts forming the join.

When providing an adhesive material, it is also possible for the adhesive material to close an intermediate space between a cable sheath and the plug connector housing.

In this respect, the adhesive material is arranged, in particular, such that it closes the intermediate space between the cable sheath and the plug connector housing by extending around the cable sheath.

The nature of the adhesive material is such that it forms an adhesive connection with the cable sheath.

The adhesive material could, for example, be introduced into, for example, be poured into the plug connector housing assembled completely from the housing parts.

One particularly favorable solution provides, however, for the adhesive material to be a gel.

Such a gel as adhesive material may preferably be already arranged in a recess in one or several of the housing parts so that the adhesive material itself also closes the joins between housing parts in a materially joined manner when the housing parts are assembled.

In order to obtain as secure a closure as possible in the area of the joins between the housing parts, it is preferably provided for the gel to be displaced partially during the assembly of the housing parts, i.e. for the adhesive material to be arranged in the housing parts which are not yet assembled such that it experiences a displacement when the housing parts are pieced together and therefore abuts on the housing parts, thereby closing the joins in a materially joined manner, as a result of the displacement in the area of the joins.

One particularly expedient solution provides for the adhesive material in the form of a gel to be inserted into at least one of the housing parts in the form of a gel body.

In this respect, it is particularly advantageous, in the case of houses designed as half shells, when a gel body is inserted into each of the half shells.

Gel bodies of this type are preferably designed such that the gel bodies form a sealing member extending completely around the cable when the housing parts are assembled, in particular as a result of the gel being displaced, in addition, in the area of surfaces of the gel bodies which touch one another and, as a result, being shaped into a gel body which closes the respective joins.

In order to have the displacement of the gel of the gel body taking place in a targeted manner, it is preferably provided for the respective gel body to have a displacement area, into which the gel can be displaced during the assembly of the gel bodies.

Alternatively or in addition, it is provided for a displacement area to be provided in the plug connector housing adjoining the receiving area for the gel body, the gel being displaced into said displacement area during the assembly of the housing parts, wherein an improved seal can be achieved as a result of the displacement of the gel.

With respect to the composition of the gel acting as adhesive material, no further details have so far been given.

One advantageous embodiment, for example, provides for the gel to be a material on a polyurethane basis.

In this respect, the gel is preferably produced from two components.

With respect to the fixing of the contact element in place in the plug connector housing, no further details have so far been given.

One advantageous solution, for example, provides for the contact element to be held in the plug connector housing in a form locking manner.

One possibility for accommodating the contact element in a form locking manner provides for the contact element to have at least one first form locking element which can be brought into engagement with a second form locking element which is formed during the assembly of the housing parts.

This solution has the advantage that, as a result, the second form locking element can also be formed during assembly of the housing parts and this accommodates the first form locking element provided on the contact element and, therefore, a stable, form locking fixing of the contact element in the plug connector housing can be achieved which can only be realized when at least two housing parts are put together in order to form the second form locking element.

In order to bring about, in addition, a strain relief for the cable in a simple manner, i.e. to achieve a corresponding fixing of the cable in position in the plug connector housing, it is preferably provided for the cable to be clamped by way of cable relief elements of the housing parts as a result of assembly of at least two housing parts.

This means that the assembly of the housing parts can also be used for the purpose of bringing about a clamping of the cable with the cable relief elements so that, in this case, no additional measures are required to fix the cable in place in the plug connector housing but rather the clamping of the cable can be brought about merely by two housing parts being joined together.

For this purpose, it is preferably provided for the cable to be accommodated between two housing parts which are preferably designed as half shells and bear the cable relief elements.

Additional features and advantages of the invention are the subject matter of the following description as well as the drawings illustrating several embodiments.

In the drawings:

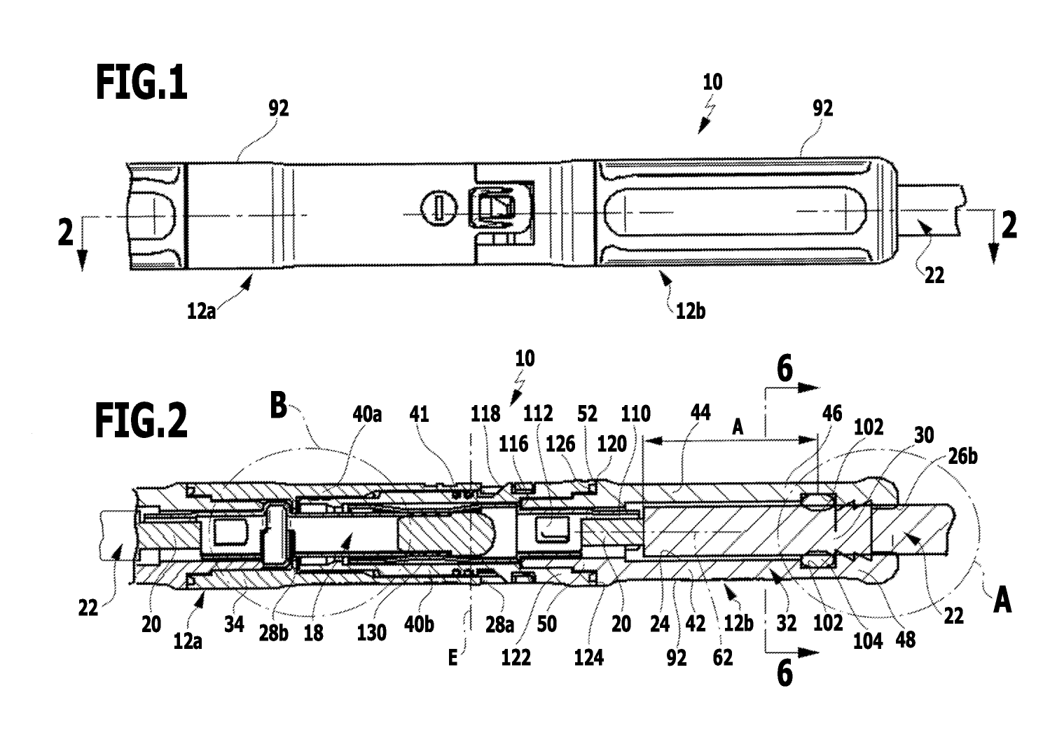

FIG. 1 shows a plan view of a plug connection with two plug connectors;

FIG. 2 shows a section along line 2-2 in FIG. 1;

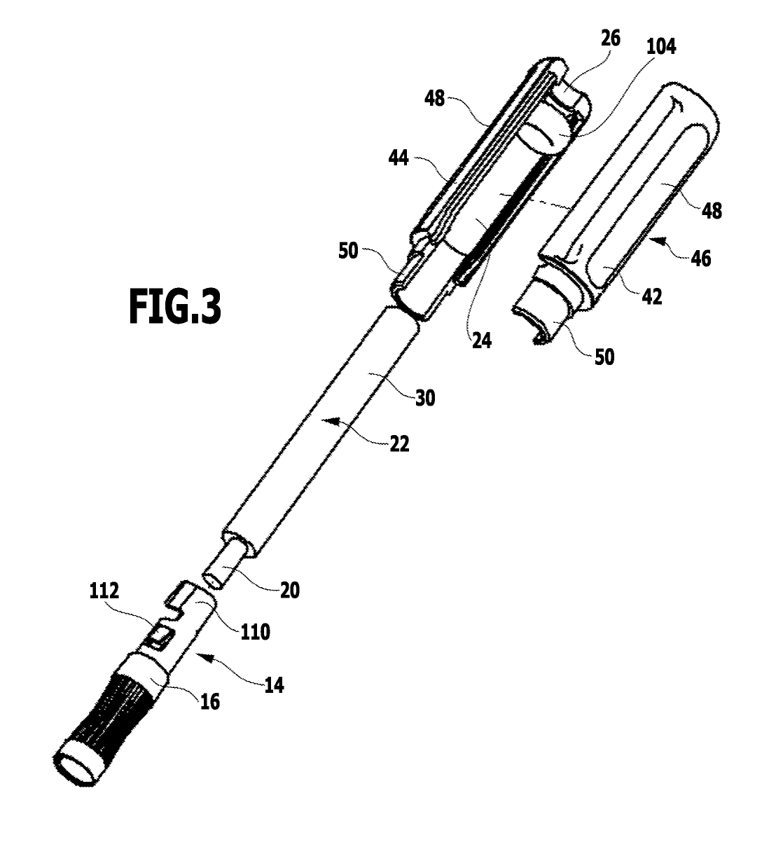

FIG. 3 shows an exploded illustration of two housing parts prior to their assembly;

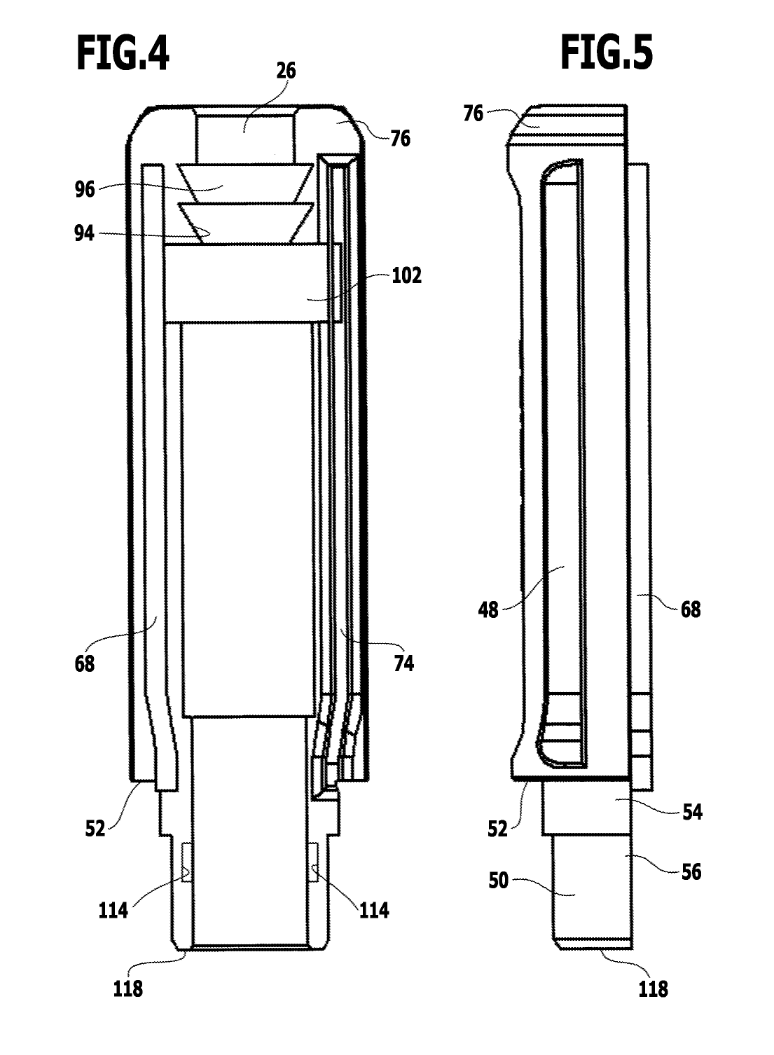

FIG. 4 shows a plan view of one of the housing parts illustrated in FIG. 3;

FIG. 5 shows a side view of the housing part illustrated in FIG. 3;

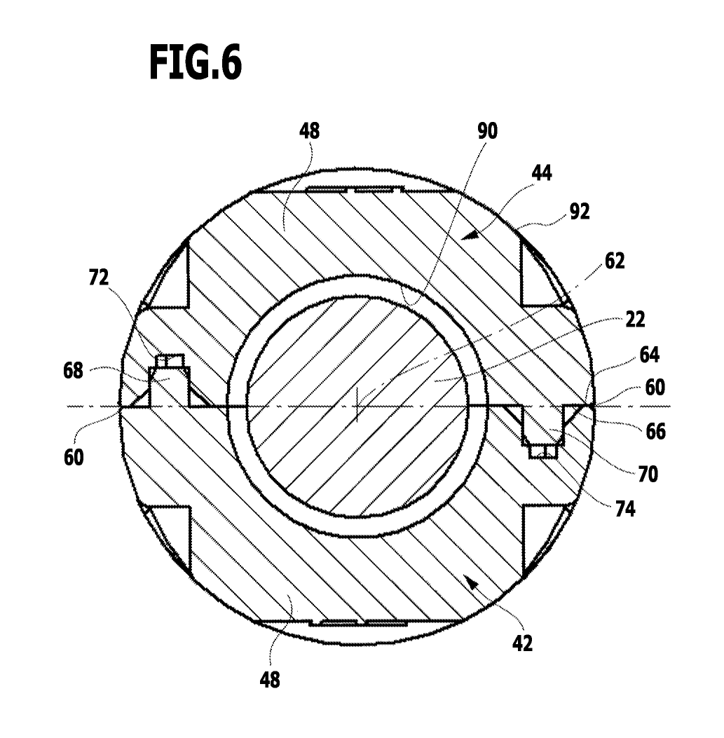

FIG. 6 shows a section along line 6-6 in FIG. 2;

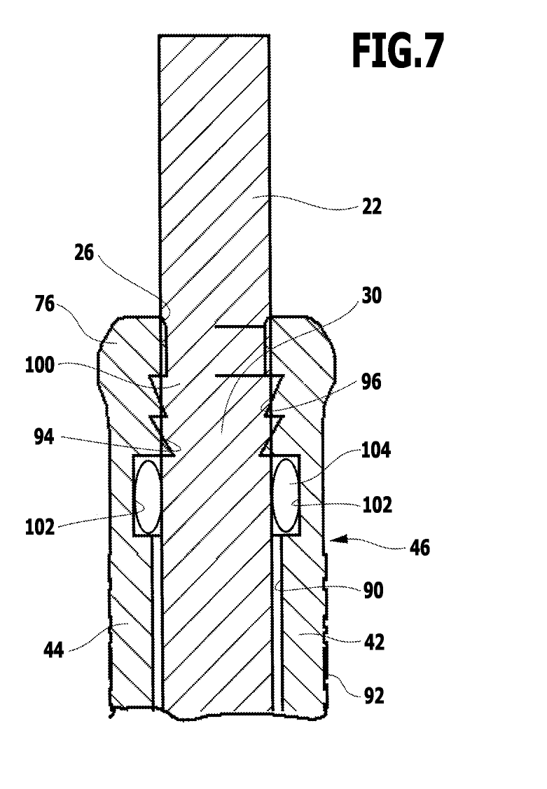

FIG. 7 shows an enlarged illustration of an area A in FIG. 2;

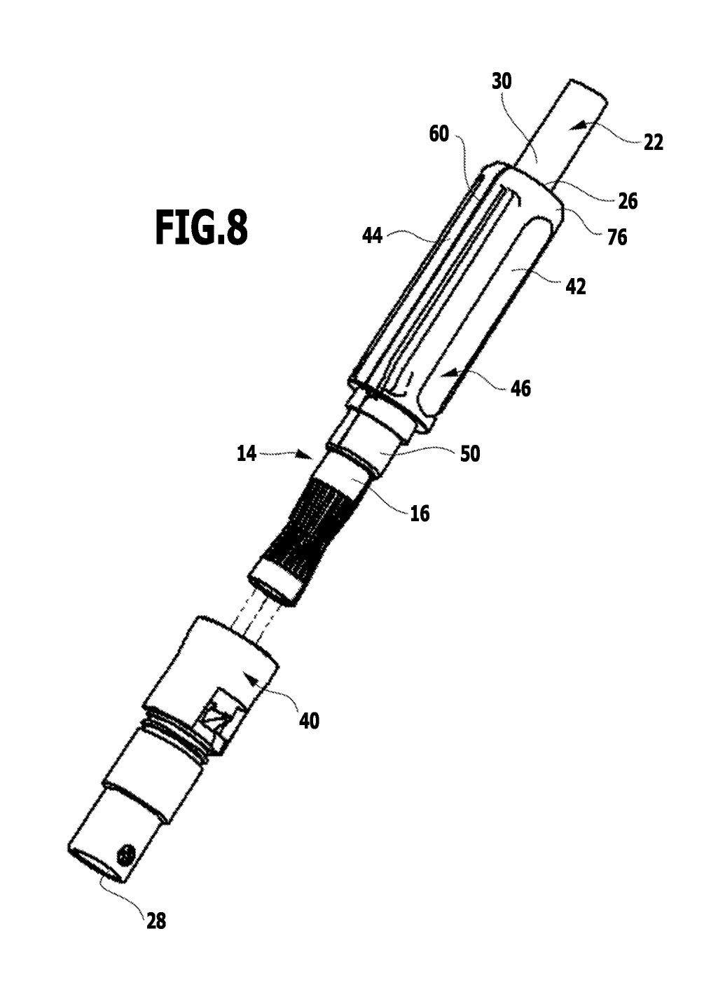

FIG. 8 shows an exploded illustration of the first embodiment, with which two housing parts are assembled to form a gripping sleeve and this is connected to a third housing part;

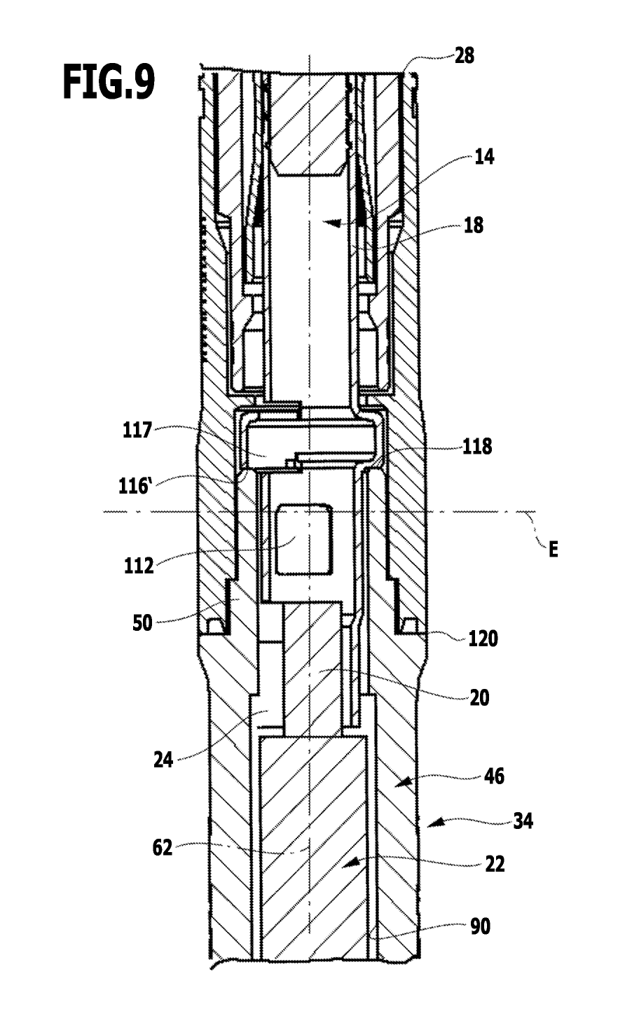

FIG. 9 shows an enlarged illustration of an area B in FIG. 2;

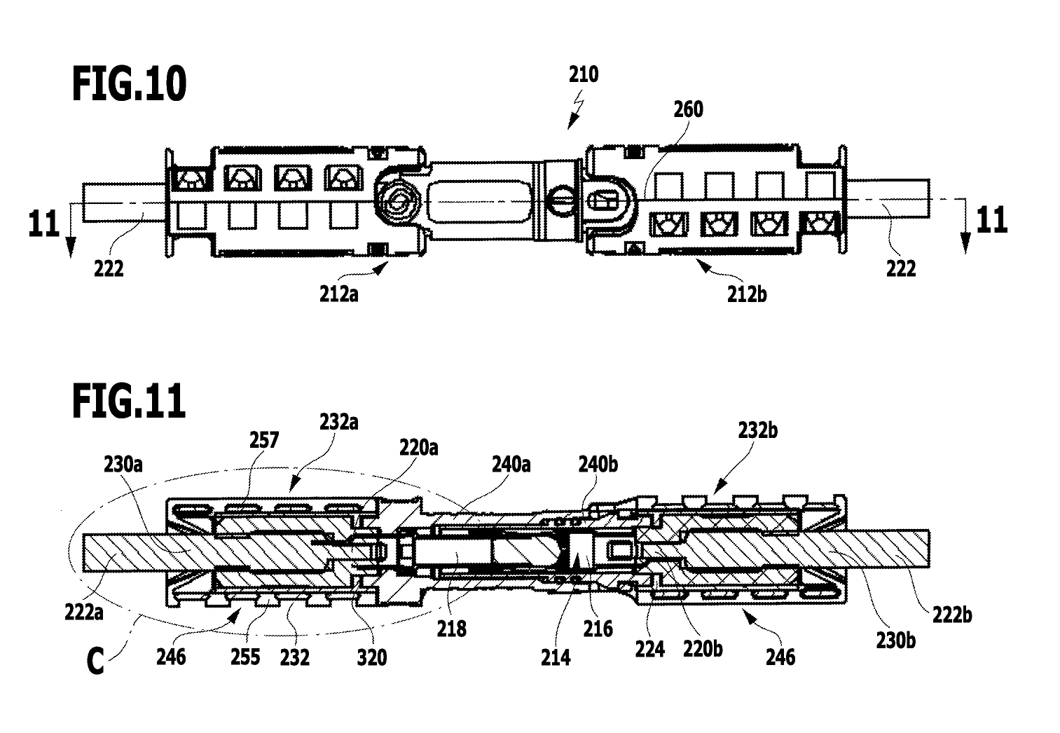

FIG. 10 shows a plan view similar to FIG. 1 of a second embodiment of a plug connection according to the invention;

FIG. 11 shows a section along line 11-11 in FIG. 10;

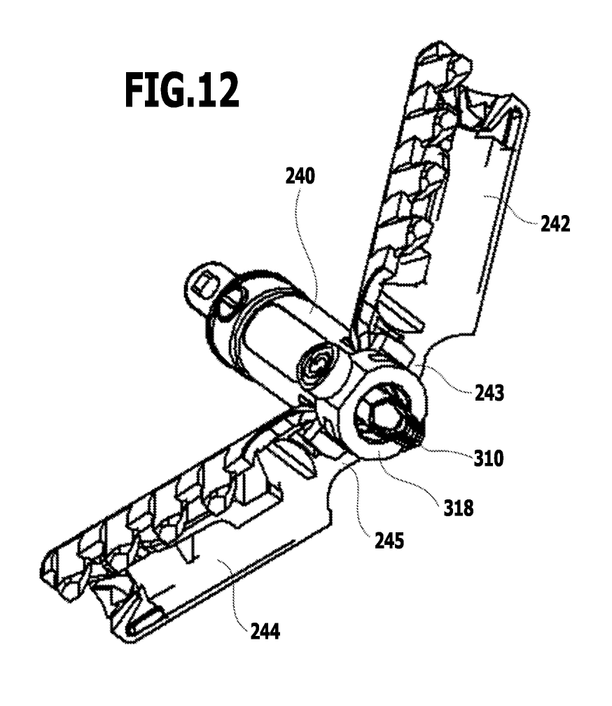

FIG. 12 shows a perspective illustration of a non-assembled plug connector housing with inserted contact element;

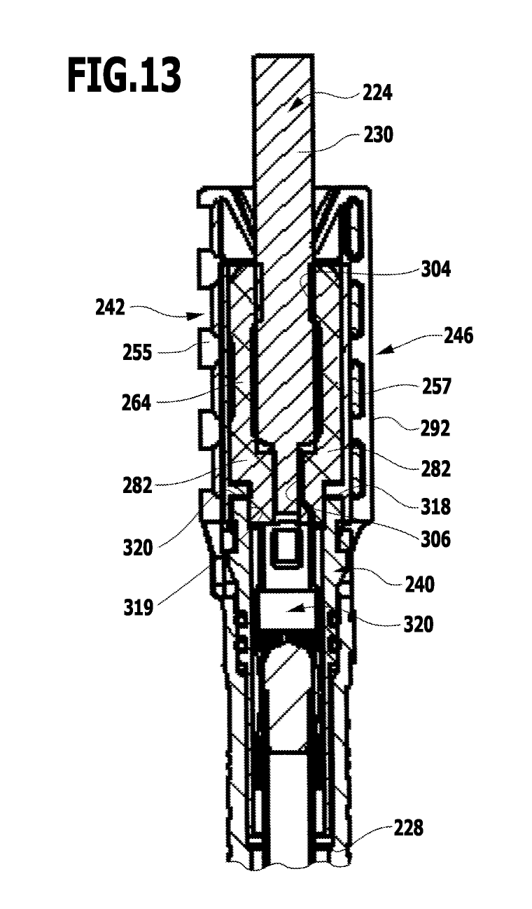

FIG. 13 shows an enlarged illustration of an area C in FIG. 11;

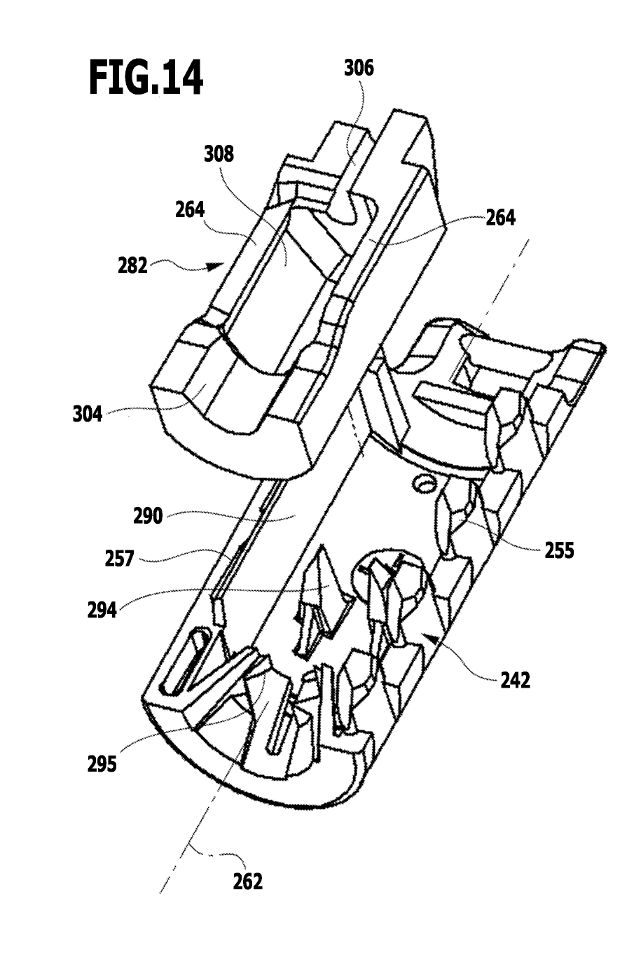

FIG. 14 shows an exploded illustration of a half shell designed as a housing part and a gel body insertable into this half shell;

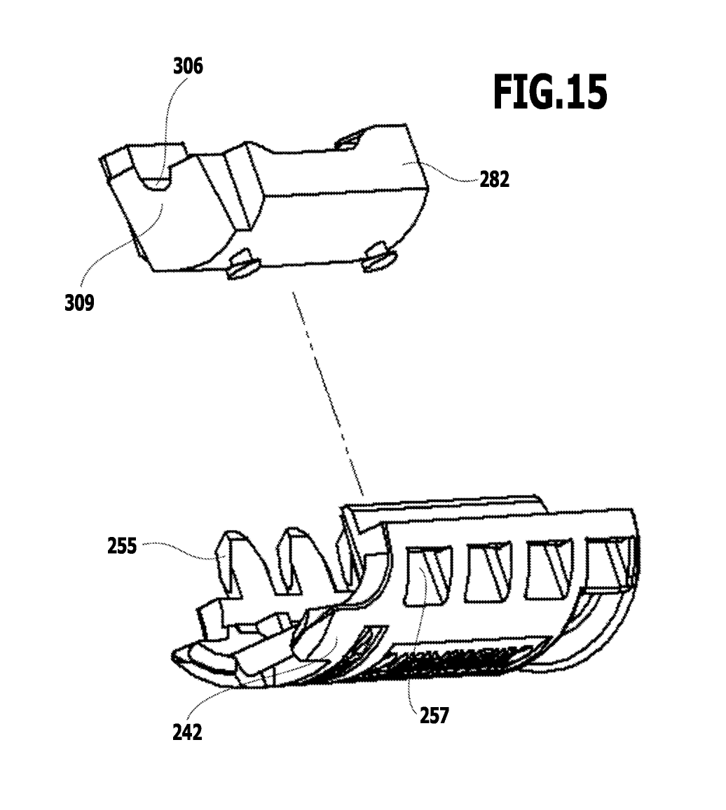

FIG. 15 shows an exploded illustration of the half shell and the gel body according to FIG. 14 from another perspective;

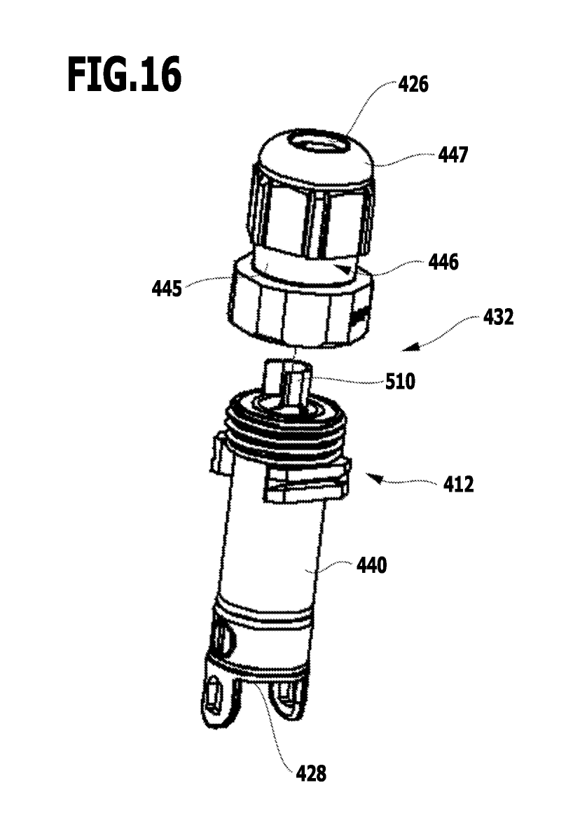

FIG. 16 shows an exploded illustration of a third embodiment of a plug connector according to the invention;

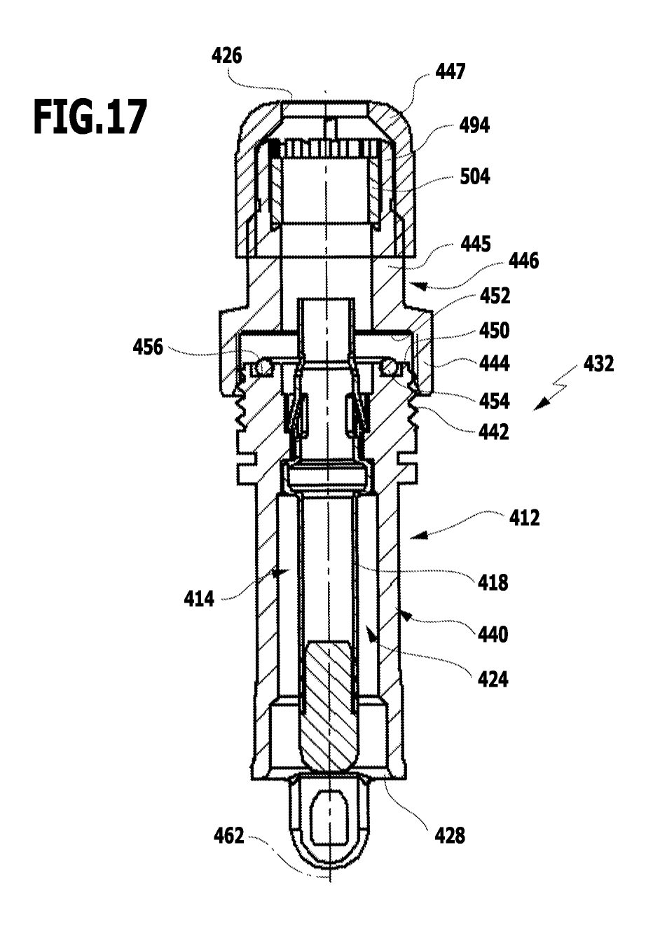

FIG. 17 shows a longitudinal section through the third embodiment of the plug connector according to the invention prior to complete connection of the housing parts thereof;

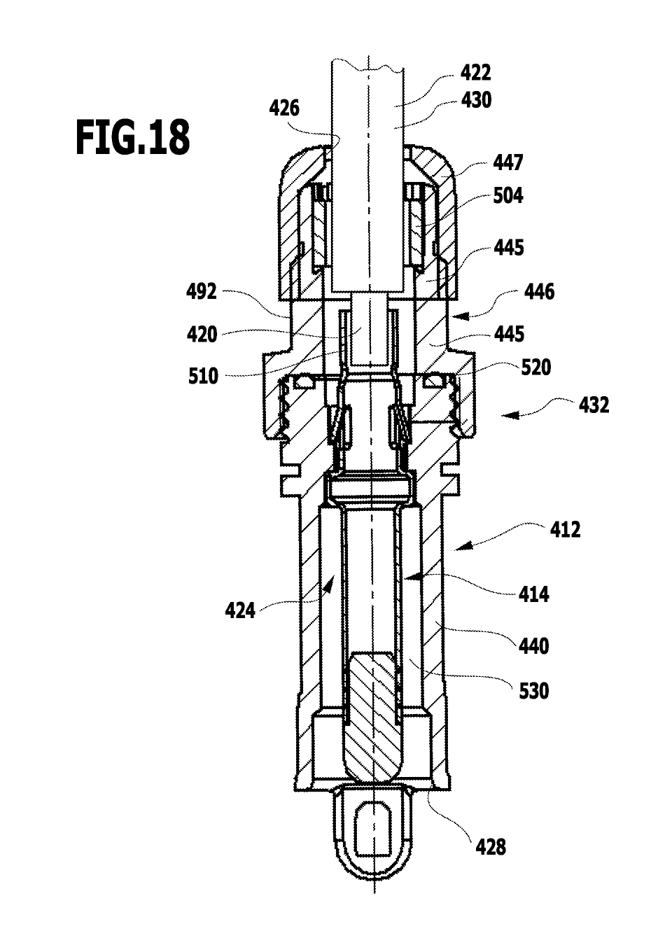

FIG. 18 shows a longitudinal section similar to FIG. 17 with completely connected housing parts thereof;

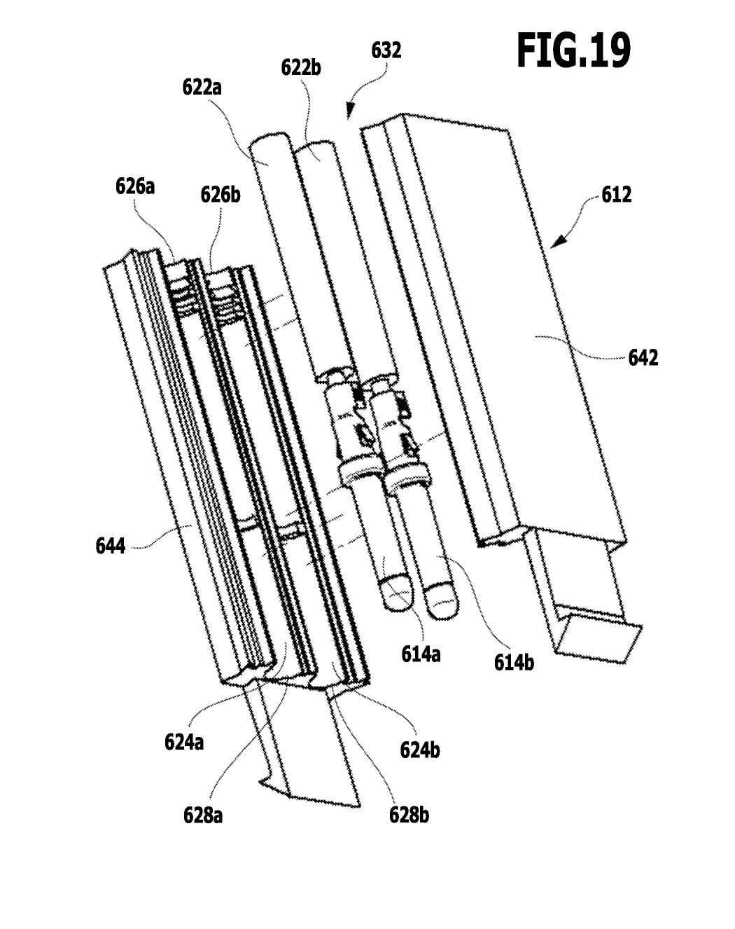

FIG. 19 shows an exploded illustration of a fourth embodiment of a plug connector according to the invention;

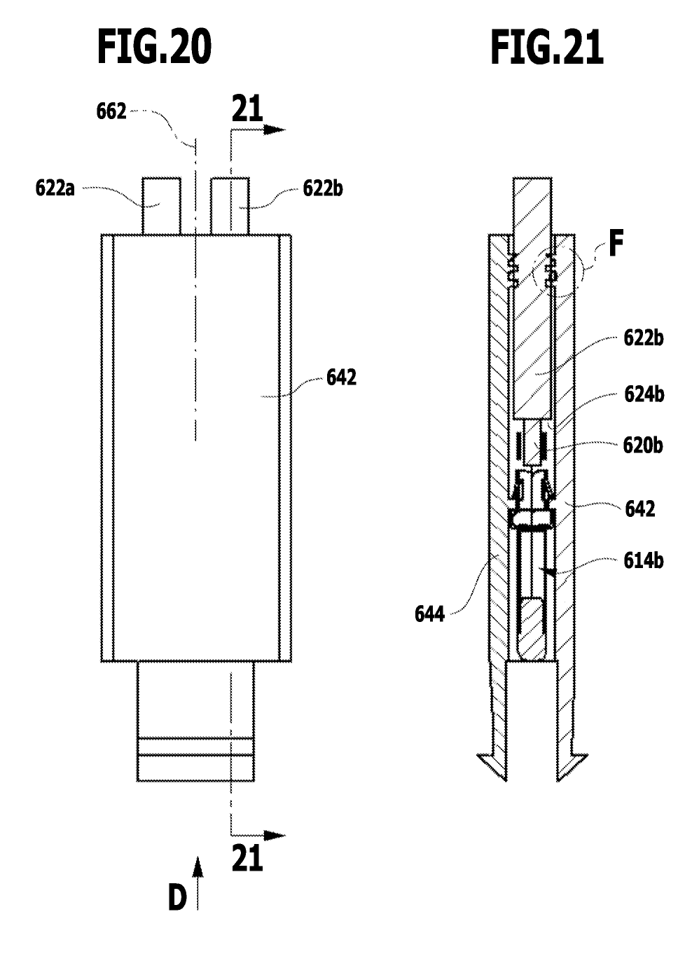

FIG. 20 shows a plan view of the fourth embodiment of the plug connector according to the invention;

FIG. 21 shows a section along line 21-21 in FIG. 20;

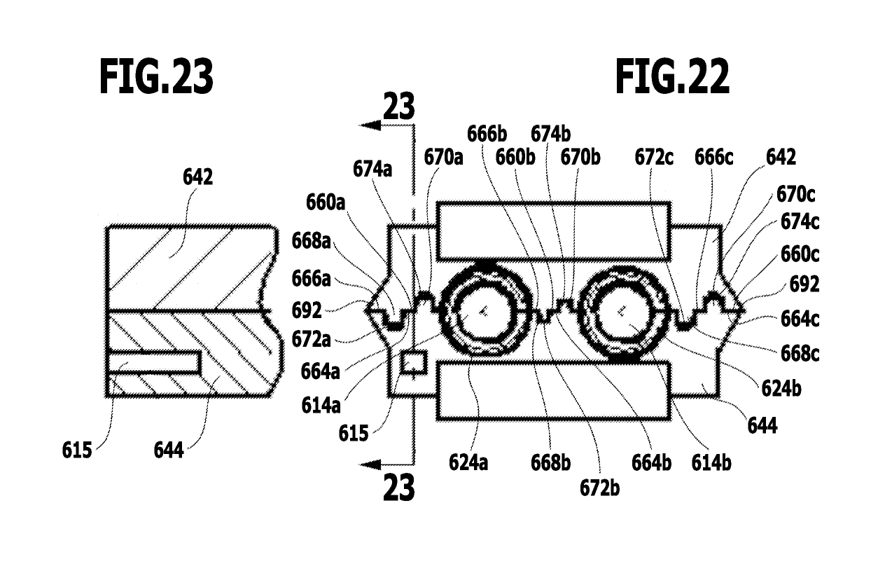

FIG. 22 shows a plan view in the direction of arrow D in FIG. 20;

FIG. 23 shows a section along line 23-23 in FIG. 22 and

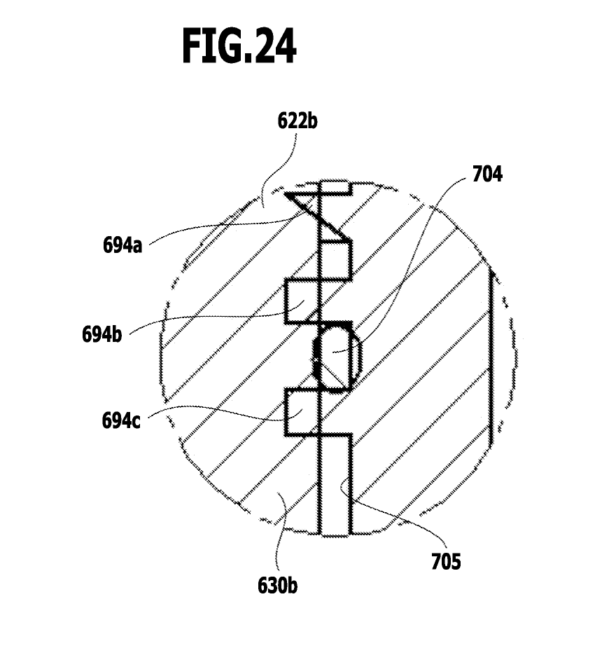

FIG. 24 shows an enlarged illustration of an area F in FIG. 21.

A first embodiment of a plug connection 10 according to the invention, illustrated in FIGS. 1 and 2, comprises two plug connectors, namely a first plug connector 12a and a second plug connector 12b which are designed to be complementary to one another and each have a contact element 14, wherein a contact sleeve 16 is arranged in one of the plug connectors 12b as contact element 14 and a contact pin 18 is arranged in the other plug connector 12a as contact element 14 and they can be connected to one another during the production of the plug connection 10.

In this respect, the contact element 14 is connected to an exposed, electrical conductor 20 of a cable 22 guided in the plug connector 12.

Both the contact element 14 and the cable 22 with the exposed, electrical conductor 20 are located in a receiving area 24 which extends from a cable opening 26 as far as a plug opening 28.

Each plug connector 12 comprises, for its part, a plug connector housing 32, in which the receiving area 24 extends and which protects the contact elements 14 and forms a respective, electrical insulating member for the protection of a person gripping the plug connector 12.

The respective plug connector housing 32 consists of a plurality of housing parts.

As will be explained in the following for the plug connector housing 32, each of the plug connector housings 32 comprises as first housing part a contact protection sleeve 40, in which the contact element 14 is arranged, as well as, as second and third housing parts, half shells 42, 44 of a gripping sleeve which is designated as a whole as 46 and into which the contact element 14 projects.

In the assembled state, the contact protection sleeves 40a and 40b are sealed relative to one another by a seal 41 which can be configured as a conventional seal or as a gel body consisting of an adhesive material, wherein the latter can preferably form an adhesive connection with the material of the contact protection sleeves 40a, 40b.

As illustrated in FIGS. 3 to 7, each of the half shells 42, 44 comprises a gripping section 48 as well as a holding extension 50, wherein the gripping section 48 merges into the holding extension 50 by means of a flange surface 52 and this holding extension has, for its part, two guiding sections 54 and 56.

A transition between the guiding surfaces 54 and 56 can be designed as a step or as an inclined surface. It is also conceivable to provide a conical surface instead of the guiding surfaces 54 and 56.

In the area of their gripping sections 48, as illustrated in FIG. 6, the half shells 42 and 44 adjoin separating joins 60 which extend parallel to a central axis 62 of the gripping sleeve 46.

In this respect, each of the half shells 42, 44 has a contact surface 64, 66 bordering on the separating joins 60 in the assembled state of the half shells 42, 44, wherein the half shells 42, 44 are designed to be mirror symmetrical to the central axis 62 and each have on one side of the central axis 62 a bar 68 and 70, respectively, which projects beyond the contact surface 64 and 66, respectively, and can engage in a corresponding recess 72 and 74, respectively, of the respectively other half shell 42, 44.

However, the respective bars 68, 70 are oversized or rather the recesses 72, 74 are undersized relative to the bars 68, 70.

On account of their oversizing or undersizing, the bars 68, 70 and the recesses 72, 74 allow ultrasonic welding of the two half shells 42, 44 for the purpose of closing the separating joins 60, namely over the entire length of the bars 68, 70 and recesses 72, 74, respectively, which extend essentially over the entire length of the gripping section 48 parallel to the central axis 62, preferably at least from the flange surface 52 as far as an end area 76 of the half shells 42, 44 which has the cable opening 26 for the insertion of the respective cables 24 and 28.

The respective bars 68, 70 and the corresponding recesses 72, 74 also preferably extend beyond the flange surface 52 as far as into the area of the guiding section 54 which adjoins the flange surface 52 so that it is ensured that a materially joined connection can be provided at least over the entire length of the gripping sleeve 46 as a result of the ultrasonic welding between the two half shells 42, 44 on both sides of the central axis 62 and this prevents the formation of creeping currents through the separating joins 60 in a radial direction in relation to the central axis 62.

As a result, no creeping currents, which could reach an outer side 92 of the gripping sleeve 46, can form in the receiving area 24 over the entire length of the gripping sleeve 46 from an inner space 90 of the sleeve accommodating the respective cable 22 through the separating joins 60 and transversely to the central axis 62.

In order to fix the respective cable 22 with its cable sheath 30 in place in the gripping sleeve 46 formed by the two half shells 42, 44, cable relief elements 94, for example in the form of claws, are provided in the half shells 42, 44 adjoining the cable opening 26 and they are arranged around a holding channel 96, into which the cable 22 can be pressed with a sheath section 100 such that the cable relief elements 94 dig into the sheath section 100 of the cable 22 and, as a result, fix the cable 22 in place in the gripping sleeve 46 composed of the two half shells 42, 44.

Furthermore, a recess 102 is also provided in the two half shells 42, 44 on a side of the holding channel 96 with the cable relief elements 94 which is located opposite the cable opening 80, a sealing element 104 being insertable into said recess, the sealing element enclosing the cable 24, for example, as a sealing ring and abutting sealingly on an outer side of the cable sheath 30, wherein the sealing element 104 likewise abuts on the cable 22 with pressure through the recesses 102 in order to provide a dust-free and moisture-tight connection between the gripping sleeve 46 and the cable 22 which, as illustrated in FIG. 2, extends at a distance A from the exposed, electrical conductor 22 and 24, respectively.

The sealing element 104 can be a conventional sealing element or also a gel body consisting of a gel which comprises an adhesive mass and forms an adhesive and, therefore, materially joined connection with the material of the half shells and/or the material of the cable sheath 30.

As illustrated in FIGS. 2 and 3, a connection between the exposed, respective electrical conductor 20 and the contact element 14 is brought about, for example, by means of a crimp section 110 which is integrally formed on the contact element 14 and pushed onto the exposed, electrical conductor 20 and crimped, i.e. can be deformed so that a force locking connection results between the crimp section 110 and the exposed, electrical conductor 20.

Furthermore, a projection 112 is provided on the contact element 14 between the crimp section 110 and the contact sleeve 16 or the contact pin 18 and this projection interacts with a corresponding recess 114 in the area of the holding extension 50 and facilitates a form locking securement of a contact element 14 in the two assembled half shells 42, 44, formed by the contact sleeve 16 or the contact pin 18, the crimp section 110 and a section bearing the projection 112.

The two assembled half shells 42, 44 with the inserted cable 22 and the contact element 14, which is connected to its electrical conductor 20 and is fixed in place in the assembled half shells 42, 44 by the projections 112 and the recesses 114 such that the contact sleeve 116 projects beyond the assembled half shells 42, 44 on a side located opposite the cable opening 80, are now inserted into the contact protection sleeve 40 such that the contact element 14 is enclosed by the contact protection sleeve 40, wherein the holding extension 50 formed by the half shells 42, 44 then engages in the contact protection sleeve 40 in an end area 122 of the contact protection sleeve 40 facing the gripping sleeve 46 and the guiding sections 54 and 56 are guided in a form locking manner in the end area 122 in order to thus obtain a stable connection between the gripping sleeve 46 and the contact protection sleeve 40. In this respect, separating joins 120 are formed which extend parallel to a plane E extending transversely to the central axis 62.

In the case of the contact element 14, in addition to the fixing in place thereof by the projections 112 engaging in the recesses 144, the contact element 14 is supported with a flange surface 116, which faces the gripping sleeve 46, on an end side 118 of the gripping sleeve 46 so that the contact element 14 is secured against any displacement in the direction of the gripping sleeve 46, in particular into it.

In contrast thereto, the flange surface 116′ of the contact element 14 comprising the contact pin 18 is, as illustrated in FIG. 9, formed by a radial recess 117 such that it can also abut on the end side 118 of the gripping sleeve 46, wherein the recess 117 is fixed in a form locking manner between a flange surface 119 of the contact protection sleeve 40 and the flange surface 116′ of the gripping sleeve 46 when they are put together to form the plug connector housing.

As for the rest, the plug connector housings 32 of the plug connectors 12 are of the same design.

Furthermore, the end area 122 has an end surface 124 which faces the flange surface 52 of the gripping sleeve 46 and has a groove 126 provided in it which allows the end surface 124 to be connected to the flange surface 52 by ultrasonic welding so that a materially joined join connection encircling the central axis 62 results by way of ultrasonic welding between the contact protection sleeve 40 and the gripping sleeve 46 and this connection prevents any formation of creeping currents via the guiding sections 56 and 54 and the flange surface 52.

Alternatively thereto, it is also possible to connect the end area 122 of the contact protection sleeve 40 by way of friction welding to the gripping sleeve 46 constructed beforehand from the half shells 42, 44, wherein, in this case, the contact protection sleeve 40 rotates.

As a result, creeping currents, which run in the receiving area 24 proceeding from the exposed, first electrical conductor 20 and the crimp section 110 or from the contact sleeve 16 or the contact pin 18, run either in the interior space 90 of the gripping sleeve 46 in the direction of the cable opening 26 or in an interior space 130 of the contact protection sleeve 40 in the direction of a plug opening 132 and so adequately long creeping current paths are available since the creeping currents cannot pass through the plug connector housings 32, 34 on a shortened path and reach the outer side 92 on account of the half shells 42 and 44 of the gripping sleeve 46 being welded to one another as well as on account of the gripping sleeve 46 being welded to the contact protection sleeve 40.

In a second embodiment of a plug connection 210 according to the invention, illustrated in FIGS. 10 to 15, with the individual plug connectors 212, of which one likewise bears the contact sleeve 216 and the other the contact pin 218 as contact element 214, the plug connector housings 232 are likewise built up of three housing parts, as described with the example of the plug connector housing 232.

This comprises, as is apparent from FIGS. 11 and 12, a contact protection sleeve 240 as well as half shells 242 and 244 which are, however, connected in an articulated manner to the contact protection sleeve 240 via pivot joints 243 and 245.

A gripping sleeve 246, into which a cable 224 runs, can also be formed with the two half shells 242 and 244, wherein the exposed, electrical conductor 220 is located within the gripping sleeve 246 and can be connected to the contact element 214 by means of a crimp section 310.

In this embodiment, the half shells 242 and 244 are, however, not welded to one another nor to the contact protection sleeve 240 in the area of their separating joins 260 and 320 but rather the half shells 242 and 244 can be connected to one another by form locking elements, preferably the interlocking elements 255 and 257, wherein, as is best apparent in FIGS. 14 and 15, the half shells 242, 244 and the interlocking elements 255, 257 integrally formed on them are designed to be mirror symmetrical to a central axis 262 of the plug connector housing 232 so that they bear the interlocking elements 255 on one side and the complementary interlocking elements 257 on the oppositely located side.

When the half shells 242 and 244 are assembled to form the gripping sleeve 246, separating joins 260 and 320 remain between the half shells 242 and 244 themselves as well as between the half shells 242 and 244 and the contact protection sleeve 240.

For this reason, a gel body designated as a whole as 282 is inserted into an interior space 290 of each of the half shells 242 and 244 and this is built up from a gel material which can, on the one hand, form an adhesive connection with an outer sheath 230 of the electric cable 224 and, in addition, an adhesive connection with the respective half shells 242 and 244 and the contact protection sleeve 240.

The gel body 282 has a receptacle 304, with which a seal which abuts adhesively and annularly on the cable sheath 230 can be formed by the two gel bodies 282 of both half shells 242, 244, as well as a receptacle 306 which is in a position to enclose the crimp section 310 with the first electrical conductor 220 lying exposed in it, wherein the gel material is likewise designed such that it forms an adhesive connection not only with the material of the crimp section 210 but also with the first electrical conductor 220.

A displacement area 308 is located between the receptacles 304 and 306 of the gel body and this is in a position to accommodate gel material displaced as a result of the cable 224 being pressed into the receptacles 304 and 306 which are of an undersized design.

Furthermore, the gel body 282 forms sealing surfaces 264 which face the respectively other gel body 282 and extend between the receptacles 304 and 306, wherein the gel bodies 282 of the two half shells 242, 244 form a sealed connection with one another in the area of the sealing surfaces 264 which extend as far as the receptacles 304 and 306 when the half shells 242, 244 are put together.

Since the sealing surfaces 264 are also of an oversized design, gel material is displaced when the gel bodies 282 abut on one another and this material can likewise enter the displacement area 308.

Furthermore, the gel body 282 has an end side 309 which projects in the direction of the contact element 214 and can be pressed against an end surface 318 of the contact protection sleeve 40 in order to provide an adhesive connection which, therefore, prohibits creeping currents between the sleeve and the two gel bodies 282.

As illustrated altogether in FIG. 13, the two gel bodies 282 of the half shells 242 and 244 therefore enclose, on the one hand, the cable 222 with the cable sheath 230 in the area of the receptacles 306, thereby forming an adhesive connection between the gel bodies 282 and the cable sheath 230 and, in addition, the gel bodies 282 also enclose the crimp section 310 as well as the exposed, electrical conductor 220 in the area of the receptacle 306 and form an adhesive connection with them.

In addition, the gel bodies 282 adhere to the sealing surfaces 264 and to the half shells 242 and 244 on their inner sides, at least in the area of the separating joins 260, in particular on account of gel being displaced during the connection of the half shells 242, 244 with the interlocking elements 255, 257, and therefore close the separating joins 260 in a materially joined manner.

Furthermore, as a result of the front side 309 of the respective gel body 282 abutting adhesively on the end surface 318 and the displacement of gel of the gel bodies 282 occurring as a result, a partial penetration of gel material into a displacement area 319 of the contact protect sleeve 242 in the area of the end surface 318 takes place, thereby filling an inner space located between it and the contact element 214, as well as abutment of the gel bodies 282 on the half shells 242, 244 in the area of the end surface 318 likewise as a result of displacement of gel so that a materially joined connection between the two gel bodies 282 and the contact protection sleeve 240 and the half shells 242, 244 with closure of the separating joins 320 results from the adhesion then occurring.

Consequently, no creeping currents can be formed, proceeding from the respective contact element 214, which run through separating joins 260 and 320 between the half shells 242 and 244 or between the half shells 242 and 244 and the contact protection sleeve 240 since the creeping currents which form, proceeding from the contact element 214, merely find a path via the plug opening 228 to the outer side 292 of the gripping sleeve 246 and this path for creeping currents is dimensioned to be of such a length that it is sufficient for the protection of any contact with the plug connector housing 232 in the area of the outer surface 292, in particular in the assembled state.

In order to fix the cable 222 in the half shells 242 and 244, respectively, each of the half shells 242, 244 is provided with cable relief elements 294 as well as elements 295 for securing against rotation which respectively dig into the cable sheath 230 when this is pressed into the half shells 242, 244 and, therefore, allow the required securement.

In a third embodiment of a plug connector according to the invention, illustrated in FIGS. 16 to 19, only one of the plug connectors, namely the plug connector 412, is illustrated and this has a contact protection sleeve 440, with which an end sleeve 446 can be connected which is, however, not constructed from two half shells but rather comprises a sleeve member 445 as well as a retaining nut 447.

The end sleeve 446 and the contact protection sleeve 440 form the plug connector housing 432, in which the receiving area 424 for the contact element 414 is arranged.

In the embodiment illustrated, the contact protection sleeve 440 is provided with a thread 442, onto which a threaded sleeve 444, which is integrally and rigidly formed on the sleeve member 445, can be screwed in order to connect the sleeve member 445 to the contact protection sleeve 440.

In order to secure a separating join 520 resulting during this connection against the formation of any creeping current passing through it, the contact protection sleeve 440 and the sleeve member 445 are provided with end sides 454 and 452 which face one another and between which a sealing ring 454 consisting of a gel material can be clamped so that the sealing ring 454 can form an adhesive and, therefore, materially joined connection with both flange surfaces 450, 452. In this respect, the sealing ring 454 is, for example, inserted into a groove 456 which can, for example, be provided in the flange surface 450 but is it, however, also conceivable to provide the groove 456 in the flange surface 452.

When the sleeve member 445 is screwed with the threaded sleeve 444 onto the thread 442 of the contact protection sleeve 440, the sealing ring 454, when crimped, will, on the one hand, abut adhesively on the flange surface 452 and, in addition, adhesively in the groove 456 and, where applicable, also adhesively on the flange surface 450 so that an adhesive connection between the contact protection sleeve 440 and the sleeve member 445 results.

Alternatively to the threaded sleeve 444 and the thread 442 for the connection of the end sleeve 446 to the contact protection sleeve 440, an interlocking connection is conceivable, with which the end sleeve 446 and the contact protection sleeve 440 can be secured relative to one another when the sealing ring 454 is crimped.

On its end area located opposite the threaded sleeve 444, the sleeve member 445 has, in addition, a ribbed cage 494, into which a sealing element 504 consisting of a gel mass is inserted which can be acted upon by the ribbed cage 494 in the direction of a sheath 430 of the cable 424 in order to, on the one hand, form an adhesive connection with a cable sheath 430 of the cable 422 and, on the other hand, form an adhesive connection with the sleeve member 445 so that no creeping currents can be formed in the direction of the cable opening 426 between the sleeve member 445 and a cable opening 480 of the retaining nut 447.

As in the remaining embodiments, the exposed, first electrical conductor 420 of the cable 422 is enclosed by the crimp section 510 of the contact element 420 and crimped by it, wherein the crimp section 510 projects beyond the flange surface 450 when the contact element 520 is seated in the contact protection sleeve 440 so that when the contact element 414 is inserted into the contact protection sleeve 440 the crimp connection between the exposed, electrical conductor 420 and the contact element 414 can be provided before the end sleeve 446 is placed over the contact protection sleeve 440.

Since, in addition, an adhesive connection between the sleeve member 445 and the contact protection sleeve 440 exists as a result of the sealing ring 454 consisting of gel material, creeping currents in the receiving area 424 merely have the possibility of running along the contact protection sleeve 440 in an interior space 530 thereof as far as the plug opening 428, wherein the creeping current path thereby resulting is sufficiently long to ensure—particularly in the assembled state—an adequate protection for any person taking hold of an outer side 492.

In a fourth embodiment of a plug connector 612 according to the invention, illustrated in FIGS. 19 to 24, two contact elements 614a and 614b, to which cables 622a and 622b lead, are arranged in a plug connector housing 632 which is built up of two half shells 642 and 644, wherein the two half shells 642, 644 form altogether two receiving areas 624a and 624b, in which contact elements 614a, 614b and the cables 622a and 622b leading to them are arranged.

Each of the receiving areas 624a, 624b extends from a cable opening 626a, 626b as far as a plug opening 628a, 628b, wherein the cables 622a, 622b enter the receiving areas 624a, 624b through the cable openings 626a and 626b whereas an electrical contact with the respective contact element 614a, 614b can be provided through the plug openings 628a, 628b by a complementary plug connector.

As illustrated in FIG. 21 and FIG. 22, joins 660a, 660b and 660c are formed between the assembled half shells 642 and 644 between contact surfaces 664a, 664b and 664c of the half shell 642 and contact surfaces 666a, 666b and 666c of the half shell 644.

Furthermore, bars 668a, 670a, 668b, 670b, 668c and 670c project beyond the contact surfaces 64 and 66 and engage in corresponding recesses 672a, 674a, 672b, 674b as well as 672c and 674c, wherein the bars 668 and 670 as well as the recesses 672 and 674 are each of an oversized design.

As a result, the two half shells 642 and 644 may be welded to one another by ultrasound, wherein in the case of the ultrasonic welding of the half shells 642 and 644 the material softens in the area of the bars 668 and 670 and the recesses 672 and 674 so that a materially joined connection results between the half shells 642 and 644 with closure of the joins 660a, 660b and 660c.

In this respect, the joins 660a and 660b are each located between one of the receiving areas 624a and 624b, respectively and an outer side 692 of the housing so that no creeping currents can be formed through the joins 670a and 670b and, consequently, creeping currents can run only along the recesses 624a and 624b to the cable opening 626a, 626b or the plug opening 628a, 628b.

Furthermore, no creeping currents can likewise be formed between the receiving areas 624a and 624b through the join 660b since the join 660b located between them is also closed in a materially joined manner, namely as a result of softening of the bars 668b and 670b and in the corresponding recesses 672b and 674b.

As a result, creeping currents which run between the receiving areas 624a and 624b must also run either as far as the plug opening 628a, 628b or the cable opening 626a, 626b so that, consequently, adequately long creeping current paths are available in the plug connector 610.

The half shells 642, 644 are preferably designed to be symmetrical to a central axis 662 of the plug connector housing 632, namely mirror symmetrical to the central axis 662 so that both half shells 642, 644 can be produced as identical parts.

In order to fix the respective cable 622a, 622b in place in the receiving areas 624a, 624b, cable relief elements 694a, 694b and 694c projecting into the receiving areas 624a, 624b are provided close to the cable opening 626a, 626b and penetrate at least partially into the cable sheath 630, in the case of FIG. 24 the cable sheath 630b, and, as a result, fix the cable 622, in this case the cable 622b, in place in the respective receiving area 624a, 624b.

Furthermore, a sealing element 704 is also provided in the area of the cable relief elements 694a, 694b and 694c and this encloses the cable sheath 630 and provides a sealed connection between this and an inner wall 705 of the half shells 642, 644.

Since, in the case of two contact elements 614a, 614b, the risk of polarity inversion exists during the production of the plug connection, a protection element 615 against polarity inversion is provided asymmetrically to the central axis 662 in the plug connector 612 according to the invention and this element is designed, for example, as a recess and can accommodate a protection pin against polarity inversion of the counter element to the plug connector 612.

1.-29. (canceled)

30. Plug connector comprising
a plug connector housing designed to be electrically insulating and consisting of a plurality of housing parts,
at least one contact element arranged in a receiving area of the plug connector housing, said contact element being accessible for a contact element of a complementary plug connector via a plug opening, and an electric cable leading into the plug connector housing via a cable opening, the electrical conductor of said cable being connected to the contact element,
joins between the housing parts and adjoining the receiving area being closed in a materially joined manner and, as a result, creeping current paths leading away from the contact element in the receiving area run exclusively to the plug opening and/or to the cable opening.

31. Plug connector as defined in claim 30, wherein the joins between the receiving area and an outer side of the plug connector housing are closed in a materially joined manner.

32. Plug connector as defined in claim 30, wherein the joins between receiving areas of the plug connector housing are connected in a materially joined manner.

33. Plug connector as defined in claim 30, wherein the plug connector housing comprises at least two housing parts.

34. Plug connector as defined in claim 30, wherein the joins between the housing parts extend parallel to a central axis of the plug connector housing.

35. Plug connector as defined in claim 33, wherein the housing parts are designed to be mirror symmetrical to the central axis.

36. Plug connector as defined in claim 33, wherein the joins between the housing parts extend parallel to a plane running transversely to the central axis.

37. Plug connector as defined in claim 30, wherein the joins between the housing parts are closed by welding the housing parts.

38. Plug connector as defined in claim 37, wherein the joins are closed by way of ultrasonic welding.

39. Plug connector as defined in claim 37, wherein grooves are provided in the area of the joins to be welded.

40. Plug connector as defined in claim 38, wherein tongue and groove elements capable of being welded to one another are provided in the area of the joins to be welded.

41. Plug connector as defined in claim 30, wherein the joins are closed by way of an adhesive material.

42. Plug connector as defined in claim 41, wherein the adhesive material is arranged in a recess of at least one of the housing parts, said recess adjoining the join.

43. Plug connector as defined in claim 42, wherein the recess is arranged in the area of an inner side of the plug connector housing.

44. Plug connector as defined in claim 41, wherein the adhesive material sticks adhesively to both the housing parts adjoining the join.

45. Plug connector comprising a plug connector housing designed to be electrically insulating and consisting of a plurality of housing parts, at least one contact element arranged in a receiving area of the plug connector housing, said contact element being accessible for a contact element of a complementary plug connector via a plug opening, and an electric cable leading into the plug connector housing via a cable opening, the electrical conductor of said cable being connected to the contact element, an intermediate space between a cable sheath and the plug connector housing being closed by way of an adhesive material.

46. Plug connector as defined in claim 45, wherein the adhesive material closes the intermediate space between the cable sheath and the plug connector housing by extending around the cable sheath.

47. Plug connector comprising a plug connector housing designed to be electrically insulating and consisting of a plurality of housing parts, at least one contact element arranged in a receiving area of the plug connector housing, said contact element being accessible for a contact element of a complementary plug connector via a plug opening, and an electric cable leading into the plug connector housing via a cable opening, the electrical conductor of said cable being connected to the contact element, an intermediate space between a cable sheath and the plug connector housing being closed by a gel.

48. Plug connector as defined in claim 47, wherein the gel is displaced following assembly of the housing parts.

49. Plug connector as defined in claim 47, wherein the gel is inserted into at least one of the housing parts in the form of a gel body.

50. Plug connector as defined in claim 49, wherein the gel bodies together form a sealing member extending around the cable in the plug connector housing.

51. Plug connector as defined in claim 49, wherein the gel body has a displacement area for displaced gel.

52. Plug connector as defined in claim 47, wherein a displacement area for displaced gel is provided in the plug connector housing.

53. Plug connector as defined in claim 47, wherein the gel is a material produced on the basis of polyurethane.

54. Plug connector as defined in claim 47, wherein the gel is produced from two components.

55. Plug connector as defined in claim 30, wherein the contact element is held in the plug connector housing in a form locking manner.

56. Plug connector as defined in claim 55, wherein the contact element has at least one first form locking element adapted to engage with a second form locking element of the plug connector housing formed as a result of assembly of at least two housing parts.

57. Plug connector as defined in claim 30, wherein the cable is adapted to be clamped between two housing parts located opposite one another.

58. Plug connector as defined in claim 57, wherein the housing parts located opposite one another each have cable relief elements embedding themselves in a cable sheath.
